(19) United States
(12) Patent Application Publication
(10) Pub. No.: US 2012/0096023 A1
(43) Pub. Date: Apr. 19, 2012

(54) APPARATUS AND METHOD FOR PROVIDING PHARMACY GUIDE

(76) Inventors: Myungeun PARK, Seoul (KR); Jiyoung HUH, Seoul (KR); Jonggsoo LEE, Seoul (KR); Seungbum HONG, Seoul (KR)

(21) Appl. No.: 12/955,718

(22) Filed: Nov. 29, 2010

(30) Foreign Application Priority Data
Oct. 15, 2010 (KR) 10-2010-0100614

(51) Int. Cl. G06F 17/30

(52) U.S. Cl. 707/769; 707/E17.014

(57) ABSTRACT

An apparatus and method for providing a pharmacy guide are discussed. The apparatus for providing a pharmacy guide includes a location obtaining module configured to obtain location information and a controller configured to obtain prescription information, determine prescribed medicines based on the prescription information, search for nearby pharmacies based on the location information, the nearby pharmacies being within a predetermined range of a location according to the location information, and choose at least one target pharmacy providing the prescribed medicines among the nearby pharmacies. An output module is configured to display the at least one target pharmacy.

### CROSS-REFERENCE TO RELATED APPLICATIONS

This application claims priority under 35 U.S.C. §119(a) on Patent Application No. 10-2010-0100614 filed in the Republic of Korea on Oct. 15, 2010, the entire contents of which are hereby incorporated by reference.

### BACKGROUND OF THE INVENTION

1. Field of the Invention

The present invention relates to an apparatus and a method for providing a pharmacy guide. More particularly, the present invention relates to an apparatus and a method for providing a pharmacy guide which searches for and displays pharmacies providing prescribed medicines based on prescription information.

2. Description of the Related Art

In the field of a medical service related to medicine, a prescription is performed at the hospital while dispensing the medicine is performed at the pharmacy. From the view point of a patient, he or she has to receive a prescription at the hospital and then visit the pharmacy to get medicines prepared according to the prescription. It is not only highly bothersome for a patient to look for a pharmacy which provides prescribed medicines and submit a prescription paper but also problematic since the patient has to wait after application in the hospital and the pharmacy respectively, thereby inevitably spending his or her time doubly.

### SUMMARY OF THE INVENTION

One object of the present invention is to provide an apparatus and a method for providing a pharmacy guide displaying location of nearby pharmacies.

Another object of the present invention is to provide an apparatus and a method for providing information about pharmacies providing prescribed medicines by obtaining and using prescription information.

A further object of the present invention is to provide an apparatus and a method for providing a pharmacy guide allowing a patient to purchase medicines without visiting a pharmacy himself or herself.

A further object of the present invention is to provide an apparatus and a method for providing a pharmacy guide enabling a patient to receive prescribed medicines without directly delivering a prescription to a pharmacist.

Technical objects that the present invention attempts to achieve are not limited to those aspects described above and technical aspects not mentioned in this document will be clearly understood from the description provided in the following by those skilled in the art.

The present invention provides an apparatus and a method for providing a pharmacy guide described below to achieve the technical objects above.

An apparatus for providing a pharmacy guide according to one aspect of the present invention includes a location obtaining module configured to obtain location information, a controller configured to obtain prescription information, determine prescribed medicines based on the prescription information, search for nearby pharmacies based on the location information, and decide target at least one target pharmacy providing the prescribed medicines among the nearby pharmacies, and an output module configured to display the at least one target pharmacy.

An apparatus for providing a pharmacy guide according to another aspect of the present invention includes a location obtaining module configured to obtain location information, a camera configured to capture an image of an object reflecting prescription information, a controller configured to obtain the prescription information by analyzing the image of a captured object, determine prescribed medicines based on the prescription information, search for nearby pharmacies based on the location information, and decide at least one target pharmacy providing the prescribed medicines among the nearby pharmacies, and an output module configured to display the at least one target pharmacy. At this time, the object includes at least one of a prescription where prescription information is written and an identification code containing prescription information.

An apparatus for providing a pharmacy guide according to further aspect of the present invention comprises a location obtaining module configured to obtain location information, a communication module configured to receive prescription information from an external device, a controller configured to obtain the prescription information from a communication module, determine prescribed medicines based on the prescription information, search for nearby pharmacies based on the location information, and decide at least one target pharmacy providing the prescribed medicines among the nearby pharmacies, and an output module configured to display the at least one target pharmacy.

An apparatus for providing a pharmacy guide according to further aspect of the present invention comprises a location obtaining module configured to obtain location information, a storage module configured to store geographic information, a controller configured to obtain prescription information, determine prescribed medicines based on the prescription information, search for nearby pharmacies based on location according to the location information by using the geographic information, and decide at least one target pharmacy providing the prescribed medicines among the nearby pharmacies, and an output module configured to display the at least one target pharmacy.

An apparatus for providing a pharmacy guide according to further aspect of the present invention comprises a location obtaining module configured to obtain location information, a communication module configured to receive medicine inventory information from an external device, a controller configured to obtain prescription information, determine prescribed medicines based on the prescription information, search for nearby pharmacies based on the location information, and decide at least one target pharmacy providing prescribed medicines among the nearby pharmacies based on the medicine inventory information, and an output module configured to display the at least one target pharmacies.

An apparatus for providing a pharmacy guide according to further aspect of the present invention comprises a location obtaining module configured to obtain location information, a controller configured to obtain prescription information, determine prescribed medicines based on the prescription information, search for nearby pharmacies based on the location information, and decide at least one target pharmacy providing the prescribed medicines among the nearby pharmacies, an output module configured to display the at least one target pharmacy, an input module configured to receive a signal selecting a pharmacy among the at least one target pharmacy, and a communication module configured to transmit a signal consisting of at least one of information related to the prescribed medicines and a request for purchasing the prescribed medicines.

An apparatus for providing a pharmacy guide according to further aspect of the present invention comprises a location obtaining module configured to obtain location information, a controller configured to obtain prescription information, determine prescribed medicines based on the prescription information, search for nearby pharmacies based on the location information, and decide at least one target pharmacy providing the prescribed medicines among the nearby pharmacies, an output module configured to display the at least one target pharmacy, an input module configured to receive a single selecting a pharmacy among the at least one target pharmacy, and a communication module configured to transmit a request signal for purchasing prescribed medicines to a selected pharmacy. At this time, the output module displays at least one of information indicating whether or not the request are accepted, information indicating whether or not the prescribed medicines are prepared, and information about time when the prescribed medicines are delivered.

An apparatus for providing a pharmacy guide according to further aspect of the present invention comprises a location obtaining module configured to obtain location information, a controller configured to obtain prescription information, determine prescribed medicines based on the prescription information, search for nearby pharmacies based on the location information, and decide at least one target pharmacy providing the prescribed medicines among nearby pharmacies, an output module configured to display the at least one target pharmacy, and an input module configured to receive a single selecting a pharmacy among the at least one target pharmacy. At this time, the output module displays additional information about the selected pharmacy including at least one of a name of the pharmacy, an address of the pharmacy, a phone number of the pharmacy, an Internet home page of the pharmacy, a pharmacist's name of the pharmacy, a business hours of the pharmacy, a medicine inventory of the pharmacy, a price of medicines provided by the pharmacy, a path from location according to the location information to the pharmacy, and a travel time required to move to the pharmacy.

An apparatus for providing a pharmacy guide according to further aspect of the present invention comprises a location obtaining module configured to obtain location information, a controller configured to obtain prescription information, determine prescribed information based on the prescription information, search for nearby pharmacies based on the location information, and decide at least one target pharmacy providing the prescribed medicines among the nearby pharmacies, and an output module configured to display the at least one target pharmacy. At this time, the controller generates a medication schedule based on the prescription information and controls the output module to output an alarm message for indicating taking the prescribed medicines.

An apparatus for providing a pharmacy guide according to further aspect of the present invention comprises a storage module configured to store prescription information, a controller configured to determine prescribed medicines based on the prescription information, and decide at least one target pharmacy providing prescribed medicines, an output module configured to display the at least one target pharmacy, an input module configured to receive a signal selecting a pharmacy among the at least one target pharmacy, and a communication module configured to transmit at least one of the prescription information and information about the prescribed medicines, and a request signal for purchasing prescribed medicines to the selected pharmacy.

An apparatus for providing a pharmacy guide according to further aspect of the present invention comprises a storage module configured to store prescription information, a controller configured to determine prescribed medicines based on the prescription information, and decide at least one target pharmacy providing the prescribed medicines, an output module configured to display the at least one target pharmacy, an input module configured to receive a signal selecting a pharmacy among the at least one target pharmacy, and a communication module configured to transmit to the selected pharmacy at least one of the prescription information and information about the prescribed medicines, and a request signal for purchasing prescribed medicines. At this time, the communication module receives at least one of information indicating whether or not the request is accepted, information indicating whether or not the prescribed medicines are prepared and information about time when the prescribed medicines are delivered, the output module displays at least one of the information indicating whether or not the request is accepted, the information indicating whether or not the prescribed medicines are prepared, and the information about the time when the prescribed medicines are delivered.

A method for providing a pharmacy guide according to one aspect of the present invention comprises obtaining prescription information, determining prescribed medicines based on the prescription information, searching for at least one target pharmacy providing the prescribed medicines, displaying the at least one target pharmacy, receiving a signal selecting a pharmacy among the at least one target pharmacy, and transmitting at least one of prescription information and information about the prescribed medicines, and a request signal for purchasing prescribed medicines to the selected pharmacy.

According to the present invention, a user can easily identify the location of a pharmacy since the location of the pharmacy is displayed considering the user's location. Also, the user can easily obtain prescribed medicines since a pharmacy providing the prescribed medicines is displayed.

According to the present invention, the user can take medicines according to a medication schedule since the medication schedule is generated by using prescription information and alarm messages are outputted at each time to take medicines.

According to the present invention, the user can purchase medicines without visiting a pharmacy himself or herself since the purchase of medicines is carried out by communication with the pharmacy.

According to the present invention, the user can receive prescribed medicines from a pharmacist without directly submitting a prescription to the pharmacist since required information for preparing and selecting medicine (for example, prescription information) is transmitted to a pharmacy and the prescription information is provided to the pharmacist by a device at the pharmacy side.

According to the present invention, the user can receive medicine without waiting for preparation of the medicine since purchase of the medicine is requested by communication.

According to the present invention, the user can use medicine and a pharmacy correctly since an overall guide about a medical service from prescription to reception of the medicine is provided.

According to the present invention, each person can lead a healthy life according to the advantages described above, and from a societal point of view, a waste of unnecessary medical costs can be reduced.

### BRIEF DESCRIPTION OF THE DRAWINGS

FIG. 1 is a perspective view of an apparatus for providing a pharmacy guide according to one embodiment of the present invention;

FIG. 2 illustrates a structure of an apparatus for providing a pharmacy guide according to one embodiment of the present invention;

FIG. 3 illustrates a communication module of an apparatus for providing a pharmacy guide according to one embodiment of the present invention;

FIG. 4 illustrates an output module of an apparatus for providing a pharmacy guide according to one embodiment of the present invention;

FIG. 5 illustrates an input module of an apparatus for providing a pharmacy guide according to one embodiment of the present invention;

FIG. 6 is a flow chart of a method for providing a pharmacy guide according to a first embodiment of the present invention;

FIG. 7 illustrates a prescription captured by a camera in a method for providing a pharmacy guide according to a first embodiment of the present invention;

FIG. 8 illustrates an identification code captured by a camera in a method for providing a pharmacy guide according to a first embodiment of the present invention;

FIG. 9 illustrates searching for nearby pharmacies in a method for providing a pharmacy guide according to a first embodiment of the present invention;

FIG. 10 illustrates receiving medicine inventory information in a method for providing a pharmacy guide according to a first embodiment of the present invention;

FIG. 11 illustrates displaying at least one target pharmacy in a method for providing a pharmacy guide according to a first embodiment of the present invention;

FIG. 12 is a flow chart of a method for providing a pharmacy guide according to a second embodiment of the present invention;

FIG. 13 illustrates selecting a pharmacy in a method for providing a pharmacy guide according to a second embodiment of the present invention;

FIG. 14 illustrates displaying additional information about a pharmacy in a method for providing a pharmacy guide according to a second embodiment of the present invention;

FIG. 15 is a flow chart of a method for providing a pharmacy guide according to a third embodiment of the present invention;

FIG. 16 is a flow chart of a method for providing a pharmacy guide according to a fourth embodiment of the present invention;

FIG. 17 illustrates communication with an external device in a method for providing a pharmacy guide according to a fourth embodiment of the present invention;

FIG. 18 illustrates a reception interface in a method for providing a pharmacy guide according to a fourth embodiment of the present invention;

FIG. 19 illustrates an interface for confirming a reception in a method for providing a pharmacy guide according to a fourth embodiment of the present invention;

FIG. 20 is a flow chart of a method for providing a pharmacy guide according to a fifth embodiment of the present invention;

FIG. 21 is a flow chart of a method for providing a pharmacy guide according to a sixth embodiment of the present invention;

FIG. 22 illustrates selecting a medicine in a method for providing a pharmacy guide according to a sixth embodiment of the present invention; and

FIG. 23 illustrates displaying additional information about a medicine in a method for providing a pharmacy guide according to a sixth embodiment of the present invention.

### DETAILED DESCRIPTION OF THE INVENTION

Terminologies used in this document have been introduced for the convenience of describing the present invention. Therefore, the present invention is not limited by the terminologies used in this document.

The present invention can be changed or modified without departing from the principles and the scope of the invention. Changes or modifications which do not depart from the principles and the scope of the present invention will be clearly understood by those skilled in the art. Therefore, the present invention comprises embodiments changed or modified which do not depart from the principle and the scope of the present invention.

The same symbols are used for the same constituting elements and descriptions repeated can be omitted.

The present invention is not limited to the embodiments described below.

In what follows, the present invention will be described with reference to appended drawings.

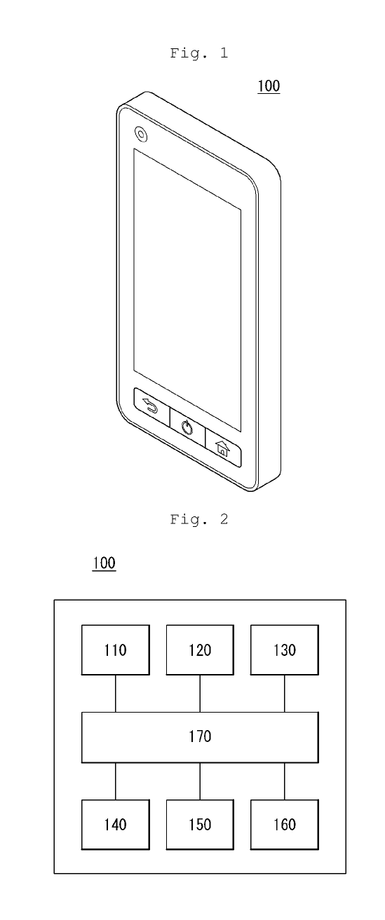

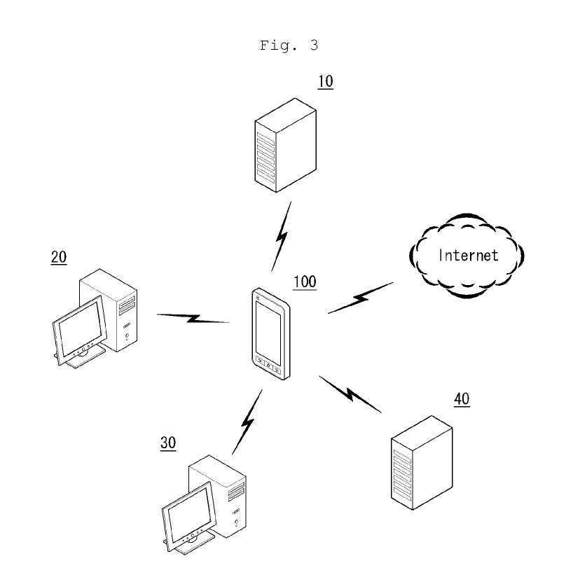

In the following, an apparatus 100 for providing a pharmacy guide according to the present invention is described with reference to FIGS. 1 and 2. FIG. 1 is a perspective view of an apparatus 100 for providing a pharmacy guide according to one embodiment of the present invention. FIG. 2 illustrates a structure of an apparatus 100 for providing a pharmacy guide according to one embodiment of the present invention. The apparatus may be a hand-held terminal having a display and a housing containing the necessary hardware and software necessary to accomplish the invention. The terminal need not be hand-held and can be a laptop or desk-top terminal.

An apparatus 100 for providing a pharmacy guide can provide a guide for pharmacies which provide prescribed medicines. The apparatus 100 for providing a pharmacy guide, when the user receives a prescription in the hospital, can provide information about pharmacies which provide the prescribed medicines. The apparatus 100 for providing a pharmacy guide can obtain prescription information, determine prescribed medicines according thereto, and display at least one target pharmacy which provides prescribed medicines among nearby pharmacies around the user. Also, the apparatus 100 for providing a pharmacy guide can provide additional information about prescribed medicines and pharmacies. In this way, when the user receives a prescription in the hospital, he or she can easily identify pharmacies which provide prescribed medicines and obtain more detailed information about the prescribed medicines and the pharmacies which provide the prescribed medicines.

The apparatus 100 for providing a pharmacy guide can also make a request to a pharmacy which provides prescribed medicines for purchasing the medicines. The apparatus 100 for providing pharmacy makes a request to a pharmacy for purchasing prescribed medicines and provides prescription information for the pharmacy by carrying out wired or wireless communication. The pharmacy which receives the request can then provide medicines for the user according to the prescription information. In this way, the user can purchase medicines easily without visiting a pharmacy.

The apparatus 100 for providing a pharmacy guide, as shown in FIGS. 1 and 2, comprises a location obtaining module 110 obtaining location information of the user's location, a camera 120 capturing the image of an object reflecting prescription information, a communication module 130 transmitting and receiving information used for a pharmacy guide by carrying out communication with at least one of a hospital-side device 20, a pharmacy-side device 30, a pharmacy guide server 10, and a geographic information server 40, an output module 140 displaying information for a pharmacy guide, an input module 150 receiving a signal for a pharmacy guide, a storage unit 160 storing information used for a pharmacy guide, the storage unit being non-transitory memory and a controller 170 controlling each constituting element of the apparatus 100 for providing a pharmacy guide and providing prescribed medicines by using location information and prescription information.

Since the apparatus 100 for providing a pharmacy guide according to the present invention does not necessarily have all of the constituting element described above, the apparatus 100 for providing a pharmacy guide can selectively comprise the constituting elements described above.

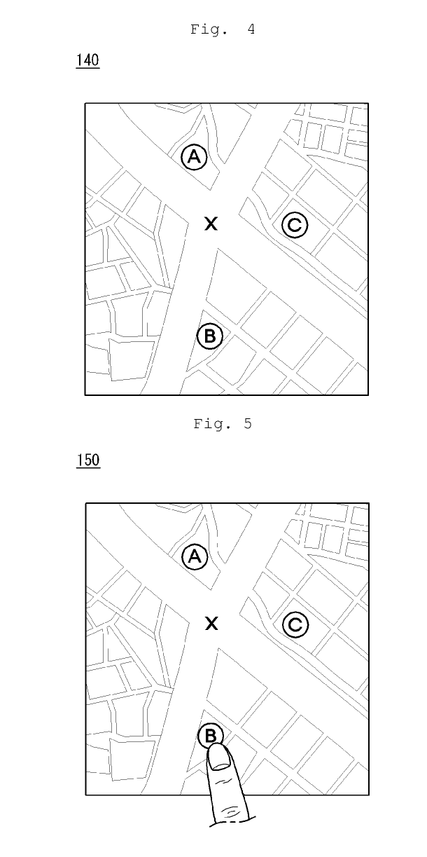

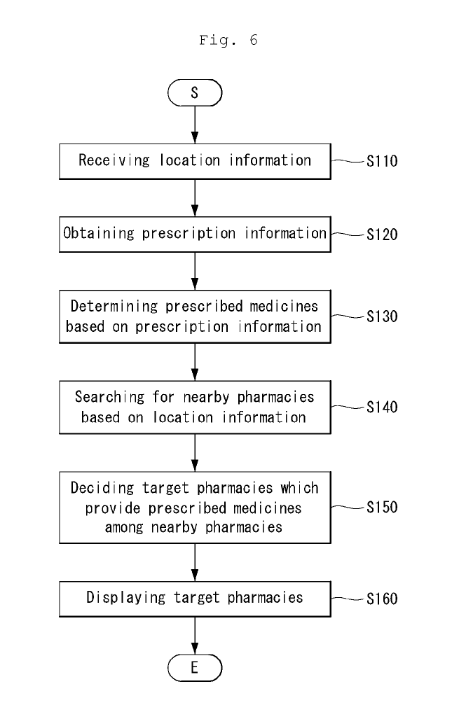

In the following, with reference to FIGS. 3, 4, and 5, constituting elements of the apparatus 100 for providing a pharmacy guide according to the present invention are described in the following order: the location obtaining module 110, the camera 120, the communication module 130, the output module 140, the input module 150, the storage module 160, and the controller 170. FIG. 3 illustrates a communication module 130 of an apparatus 100 for providing a pharmacy guide according to one embodiment of the present invention. FIG. 4 illustrates an output module 140 of an apparatus 100 for providing a pharmacy guide according to one embodiment of the present invention. FIG. 5 illustrates an input module 150 of an apparatus 100 for providing a pharmacy guide according to one embodiment of the present invention.

The location obtaining module 110 can obtain location information from an external device. At this time, location information can include information about the user's location or information about the location of the apparatus 100 for providing a pharmacy guide. For example, the location obtaining module 110 can obtain location information by utilizing global positioning system (GPS). The location obtaining module 110 can include a GPS receiver and obtain location information by receiving GPS signal from GPS satellites and calculating the location based on the GPS signal. The location obtaining module 110 can obtain the location information described above and transmit the obtained location information to the controller 170, the controller 170, after receiving the location information, can search for nearby pharmacies based on the location according to the location information.

The camera 120 can capture an image of an object reflecting prescription information. The object which reflects prescription information can include at least one of an identification code such as a quick response (QR) code including prescription information and a prescription in which the prescription information is written. The camera 120 obtains the image of an object by taking a picture thereof. The controller 170 can obtain prescription information by analyzing the captured image of the object and determine prescribed medicines according to the prescription information.

The communication module 130 can perform communication with an external device. As shown in FIG. 3, an external device can include at least one of a hospital-side device 20, a pharmacy-side device 30, a pharmacy guide server 10, a geographic information server 40, a mobile communication terminal, a personal computer, and an Internet site. The communication module 130 can perform communication in various ways through a wired and a wireless communication network with various external devices above. For example, the communication module 130 can perform wired communication by utilizing at least one of universal serial bus (USB) and RS-232 communication. In other examples, the communication module 130 can perform wireless communication by utilizing at least one of Wi-Fi, Wibro, Bluetooth, Zigbee, RF, and IrDA communication. A communication method employed by the communication module 130 is not limited to the examples above but can further include various methods supporting transmitting and receiving information to and from various external devices.

The communication module 130 can transmit and receive information used for a pharmacy guide by performing communication with an external device. For example, the communication module 130 can receive an electronic prescription from a hospital-side device 20. In another example, the communication module 130 can receive information about the inventory of medicines in stock from a pharmacy-side device 30. In still another example, the communication module 130 can receive geographic information from a geographic information server 40. At this time, geographic information includes various kinds of geographic information according to location. The geographic information can include information about hospitals and pharmacies according to location. In a further example, the communication module 130 can transmit a signal requesting purchase of prescribed medicines to the pharmacy-side device 30 and receive a response about the request. The controller 170 can then control the apparatus 100 for providing a pharmacy guide to guide pharmacies by using various kinds of information transmitted and received by the communication module 130.

The output module 140 can output information to the outside. In doing so, the user can receive information from the apparatus 100 for providing a pharmacy guide. The output module 140 can output information in various ways. The output module 140 can output information by using at least one of a visual signal, an auditory signal, and a tactile signal. The output module 140 can include at least one of a display, a touch screen, a speaker, a vibrator, and various other output devices.

The output module 140 can provide various kinds of information. For example, the output module 140 can display at least one target pharmacy providing prescribed medicines as shown in FIG. 4.

The input module 150 can receive information from the outside. The input module 150 can receive information in various ways. The input module 150 can receive information according to at least one of a keystroke signal, a touch signal, a gesture signal, a voice signal, and an image signal. The input module 150 can include at least one of a keyboard, a mouse, a touch screen, a microphone, and various other input devices.

The input module 150 can receive various kinds of information or signals. For example, the input module 150 can receive a touch signal selecting a pharmacy among at least one target pharmacy through a touch screen as shown in FIG. 5. The controller 170 can then control the output module 140 to display additional information about the selected pharmacy based on the input signal.

The storage module 160 can store information related to a pharmacy guide. The storage module 160 can store information by receiving the information from at least one of the location obtaining module 110, the camera 120, the communication module 130, the input module 150, and the controller 170. The information related to a pharmacy guide can include at least one of location information, geographic information, an image of an object reflecting prescription information, prescription information, information about prescribed medicines, medicine inventory information, additional information about pharmacies, additional information about medicine, a medication schedule, and other information.

The controller 170 can decide at least one target pharmacy providing prescribed medicines based on location information and prescription information. The controller 170 can also control other constituting elements of the apparatus 100 for providing a pharmacy guide so that the apparatus 100 for providing a pharmacy guide can carry out a pharmacy guide. The controller 170 can include a microprocessor. Detailed description about the controller 170 will be provided later in the description about a method for providing a pharmacy guide according to the present invention.

In the following, a method for providing a pharmacy guide according to the present invention will be described.

A method for providing a pharmacy guide according to the present invention is described by using the apparatus 100 for providing a pharmacy guide according to the present invention. At this time, the apparatus 100 for providing a pharmacy guide is introduced for the convenience of describing a method for providing a pharmacy guide according to the present invention. Therefore, a method for providing a pharmacy guide is not limited to the apparatus 100 for providing a pharmacy guide according to the present invention.

A method for providing a pharmacy guide according to the present invention can be carried out by using other devices which provide the same functions as the apparatus 100 for providing a pharmacy guide according to the present invention.

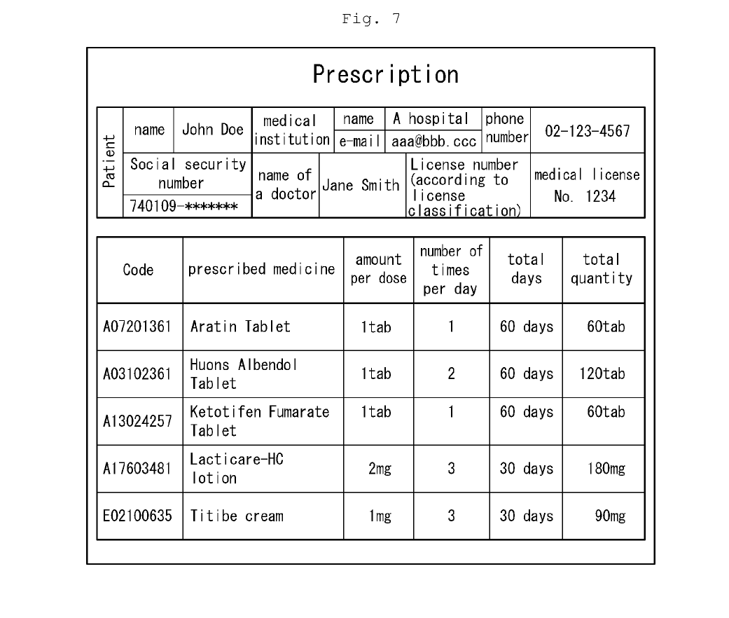

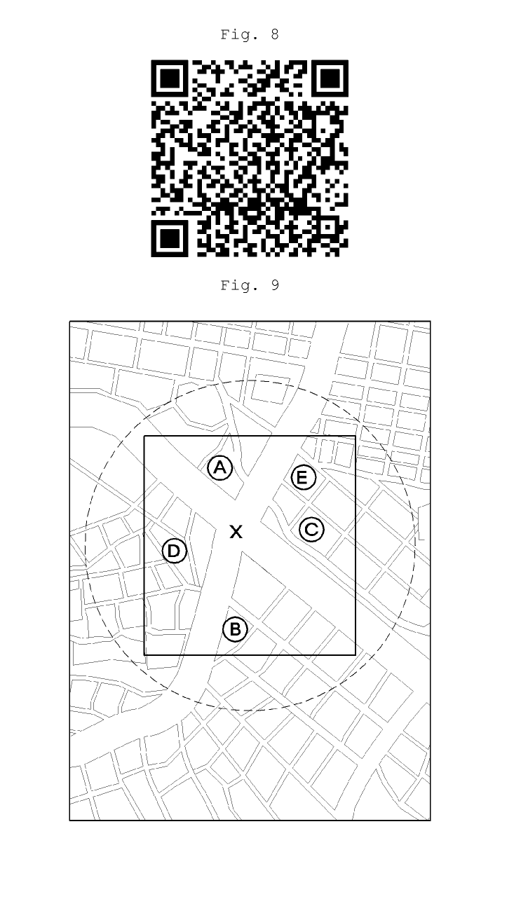

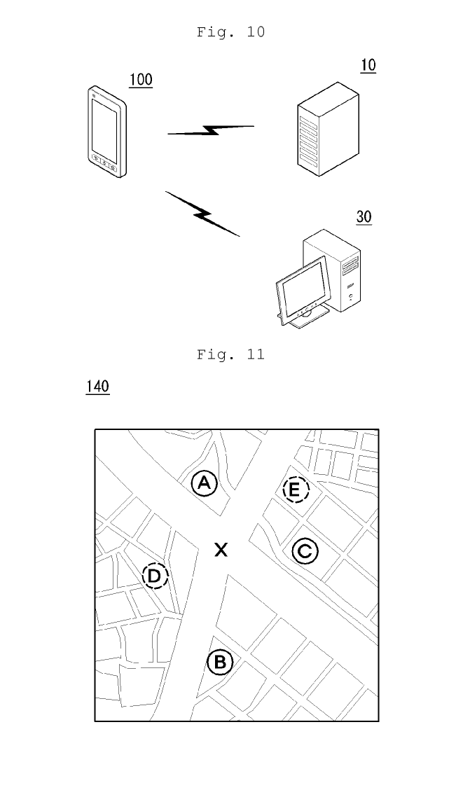

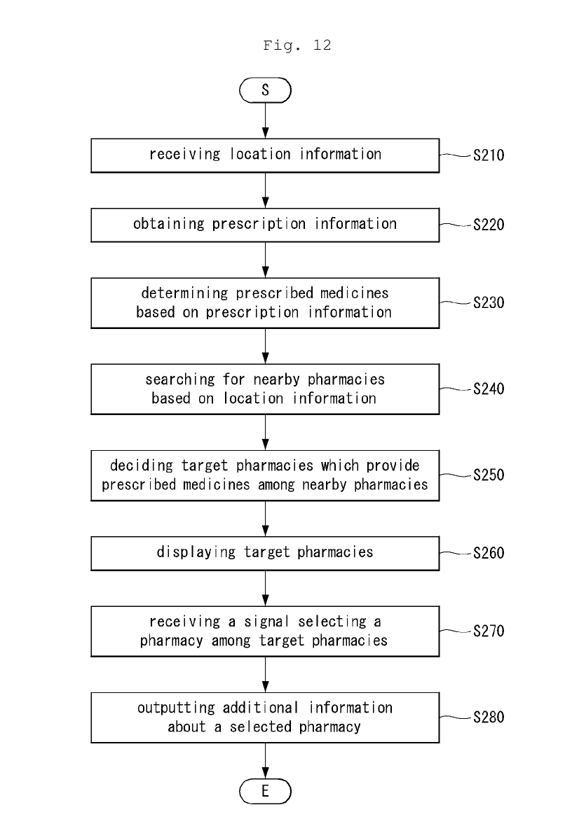

In the following, a method for providing a pharmacy guide according to a first embodiment of the present invention will be described with reference to FIGS. 6, 7, 8, 9, 10, and 11. FIG. 6 is a flow chart of a method for providing a pharmacy guide according to a first embodiment of the present invention. FIG. 7 illustrates a prescription captured by a camera in a method for providing a pharmacy guide according to a first embodiment of the present invention. FIG. 8 illustrates an identification code captured by a camera in a method for providing a pharmacy guide according to a first embodiment of the present invention. FIG. 9 illustrates searching for nearby pharmacies in a method for providing a pharmacy guide according to a first embodiment of the present invention. FIG. 10 illustrates receiving medicine inventory information in a method for providing a pharmacy guide according to a first embodiment of the present invention. FIG. 11 illustrates displaying at least one target pharmacy in a method for providing a pharmacy guide according to a first embodiment of the present invention.

As shown in FIG. 6, a method for providing a pharmacy guide according to a first embodiment of the present invention comprises at least one of receiving location information S110, obtaining prescription information S120, determining prescribed medicines based on prescription information S130, searching for nearby pharmacies based on location information S140, deciding at least one target pharmacy providing prescribed medicines among nearby pharmacies S150, displaying at least one target pharmacy S160. In what follows, individual steps of the method for providing a pharmacy guide according to the first embodiment of the present invention will be described.

The apparatus 100 for providing a pharmacy guide can receive location information by using the location obtaining module 110. The location information can include at least one of location of the user, location of the apparatus 100 for providing a pharmacy guide, and information about location of a hospital where the user has received a prescription after medical treatment. The location obtaining module 110 can receive the location information from an external device. For example, the location obtaining module 110 can include a GPS receiver and the GPS receiver can receive GPS signals from GPS satellites. Then, at least one of the controller 170 and the location obtains location information by calculating the location based on the GPS signals. The GPS receiver can receive GPS signals from at least one GPS satellite. As the number of GPS satellites transmitting GPS signals is increased, the location information will be more accurate. In another example, the location obtaining module 110 can receive location information through a hospital-side device 20, a mobile communication terminal, and an Internet site. In still another example, the location obtaining module 110 can receive location information by the user's inputting a signal about the location.

The location obtaining module 110 which receives or obtains the location information as described above can store the location information in the storage module 160 or transmit the location information to the controller 170. The controller 170 can use the location information to search for nearby pharmacies.

The apparatus 100 for providing a pharmacy guide can obtain prescription information S120 by using the controller 170. The prescription information can include information about medical comments written based on findings obtained as a prescriber examines and treats a patient. The prescription information can include at least one of a prescriber, a patient, time when prescription has been made, a hospital where prescription has been made, prescribed medicines, directions for taking prescribed medicines, and cautions for taking prescribed medicines. At this time, a prescriber includes a doctor or a physician comparable to a doctor in a broad sense. For example, a prescriber can include a veterinarian or a health manager. A patient does not necessarily mean only a human suffering from illness. A patient corresponds to a person who receives a medical treatment from a prescriber and includes an animal in a broad sense.

The controller 170 can obtain the prescription information in various ways. First, the camera 120 can take an image of an object reflecting prescription information and the controller 170 can extract the prescription information by analyzing the captured image. At this time, the object, the image of which is captured by the camera 120, can be varied.

For example, the camera 120 can take an image of a prescription written by a doctor. In this case, prescription information can be written in the prescription. The camera 120 obtains an image of the prescription and the controller 170 can obtain the prescription information by analyzing the image of the prescription. For example, a prescription can be a document written manually by a doctor, a printed or typed document according to a predetermined form as shown in FIG. 7. The controller 170 can recognize characters by using a character recognition algorithm such as OCR(optical character recognition). The storage module 160 can store a database related to prescription information and the controller 170 can obtain the prescription information indicated by recognized characters by using the database related to the prescription information. Specifically, as shown in FIG. 7, the name of a medicine and a code assigned to the medicine can be written in a prescription. The controller 170 can recognize characters indicating the name of a medicine and a code assigned to the medicine and obtain prescription information by comparing the recognized characters with the database.

In another example, the camera 120 can take an image of an identification code which contains prescription information. The identification code is a code encoded according to a predetermined rule, which can be composed of at least one of encoded diagrams, symbols, and characters. The identification code can take the form of a barcode and specifically can include a one-dimensional barcode and a two-dimensional barcode. At this time, as shown in FIG. 8, a two-dimensional barcode can be a matrix code or a QR code and reflect prescription information encoded by at least one of diagrams, symbols, and characters prepared on a two-dimensional plane. A two-dimensional barcode can store more information than a one-dimensional barcode. The camera 120 obtains an image of an identification code as described above and the controller 170 can then decode the image of the identification code according to a decoding method of each identification code, thereby obtaining prescription information contained in the identification code.

Second, the communication module 130 can receive prescription information and the controller 170 can obtain prescription information through the communication module 130. The communication module 130 can receive the prescription information from a hospital-side device 20 or a pharmacy guide server 10. The pharmacy guide server 10 can be a server which collects, manages, processes, and provides overall information related to a pharmacy guide. For example, the pharmacy guide server 10 can receive prescription information from the hospital-side server 20 or receive prescription information from a doctor and store the prescription information and provide the prescription information to the apparatus 100 for providing a pharmacy guide through the communication module 130. The controller 170 can obtain the prescription information through the communication module 130. At this time, since the prescription information deals with personal information, security of the information is important, Therefore, the prescription information can be encoded according to a predetermined method. The prescription information encoded can be prepared to be decoded once authentication is completed through an authentication procedure and the controller 170 can then obtain decoded prescription information through a procedure decoding the encoded prescription information obtained from the communication module 130.

Third, the input module 150 can receive prescription information from the user and the controller 170 can obtain the prescription information through the input module 150. An input method can be carried out by a touch input through a touch screen, an input through a keyboard, or a voice input through a microphone.

Fourth, the communication module 130 can receive prescription information from an object containing the prescription information. The object containing the prescription information can include an object which can transmit prescription information to the communication module 130 through short range communication. To be specific, an object can include a radio frequency identification (RFID) tag.

The apparatus 100 for providing a pharmacy guide can determine prescribed medicines based on prescription information S130 by using the controller 170. As described above, prescription information can include the name of a prescribed medicine or a medicine code corresponding to the prescribed medicine. The controller 170 can determine prescribed medicines by extracting information about the prescribed medicines from the prescription information. For example, the storage module 160 stores a database related to the name of a medicine or a code corresponding to the medicine and the controller 170 can then extract the name of a medicine or a code corresponding to the medicine from the prescription information, and the controller 170 can determine prescribed medicines by comparing the extracted information with the database.

The apparatus 100 for providing a pharmacy guide can search for nearby pharmacies based on location information by using the controller 170. The controller 170 can search for nearby pharmacies located within a predetermined range based on the location according to the location information. The controller 170 can search for a predetermined number of nearby pharmacies. Herein, the controller 170 can search the predetermined nearby pharmacies which are the closest pharmacies from the location according to the location information. For example, when the predetermined number is four, the controller 170 can search the first closest pharmacy, and then search the second, third, fourth closest pharmacy from the location.

For example, the communication module 130 can receive geographic information from the geographic information server 40. Or the storage module 160 can store geographic information. At this time, geographic information can include information about a soil, resources, environments, cities, the ocean, marine products, armed forces, transportation, communication, water supply and drainage, and buildings. Particularly, geographic information in the present invention can include location information about at least one of a hospital and a pharmacy. The controller 170 can obtain location information from the location obtaining module 110 and the communication module 130 can obtain geographic information from the storage module 160. The controller 170 can search for pharmacies located within a predetermined range by using geographic information based on the location according to the location information. As shown in FIG. 9, the location can be the location of the user and pharmacies found can be nearby pharmacies within a predetermined range from the location of the user.

In another example, the controller 170 can obtain location information from the location obtaining module 110 and transmit the location information to an external device such as a geographic information server 40 through the communication module 130. The geographic information server 40 can search for nearby pharmacies within a predetermined range based on the location according to the received location information by using geographic information stored and transmit information about nearby pharmacies found to the apparatus 100 for providing a pharmacy guide. The controller 170 can receive information about nearby pharmacies through the communication module 130.

In still another example, the controller 170 can obtain location information and connect to the geographic information server 40 through the communication module 130 and search for nearby pharmacies by using geographic information stored in the geographic information server 40.

The apparatus 100 for providing a pharmacy guide can choose at least one target pharmacy which provides the prescribed medicines among nearby pharmacies by using the controller 170. The controller 170 can choose at least one target pharmacy which provides the prescribed medicines among nearby pharmacies based on medicine inventory information. At this time, the medicine inventory information can include information about medicines provided by pharmacies. For example, the medicine inventory information can include information about medicines in stock at a pharmacy or medicines which can be prepared at a pharmacy and information about the amount of medicines in stock. The storage module 160 can store the medicine inventory information. Or the communication module 130 can receive the medicine inventory information from an external device such as a pharmacy guide server 10 or a pharmacy-side device 30 as shown in FIG. 10. At this time, the pharmacy guide server 10 can construct a database about medicine inventory information of a plurality of pharmacies and provide overall medicine inventory information. The pharmacy-side device 30 is a device placed in a pharmacy and can receive medicine inventory information of a pharmacy from the corresponding pharmacy and provide the medicine inventory information. The controller 170 can obtain the medicine inventory information from the storage module 160 or the communication module 130 and determine at least one target pharmacy among nearby pharmacies based on the medicine inventory information. As shown in FIG. 9, if pharmacies of A, B, C, D, and E are found as nearby pharmacies, by using medicine inventory information, the controller 170 can determine at least one target pharmacy which provide prescribed medicines as pharmacies A, B, and C as shown in FIG. 11.

The apparatus 100 for providing a pharmacy guide can display at least one target pharmacy S160.

The output module 140 can display at least one target pharmacy determined by the controller 170. The controller 170 can control the output module 140 to display at least one target pharmacy. For example, as shown in FIG. 11, the controller 170 can control the output module 140 to display a map of a predetermined range based on the location according to location information by using geographic information and to display at least one target pharmacy on the map.

According to the apparatus 100 for providing a pharmacy guide according to the first embodiment of the present invention, by displaying pharmacies in consideration of the user's location, the user can easily identify the location of a pharmacy. In addition, by displaying pharmacies which provide prescribed medicines by obtaining prescribed information, the user can easily obtain prescribed medicines.

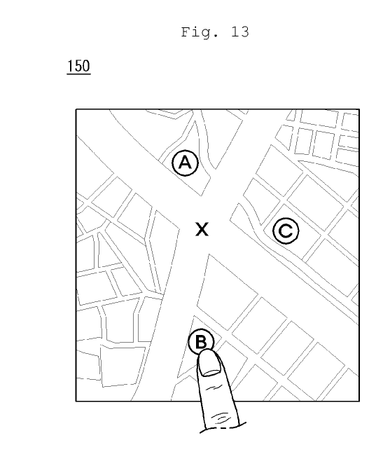

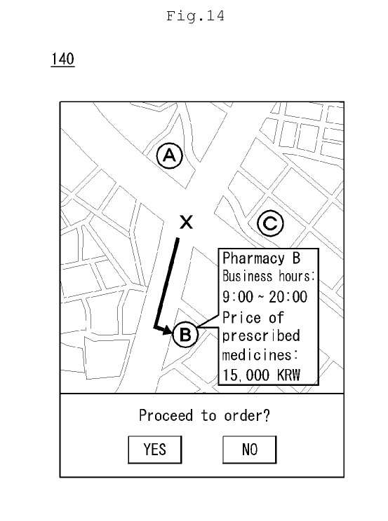

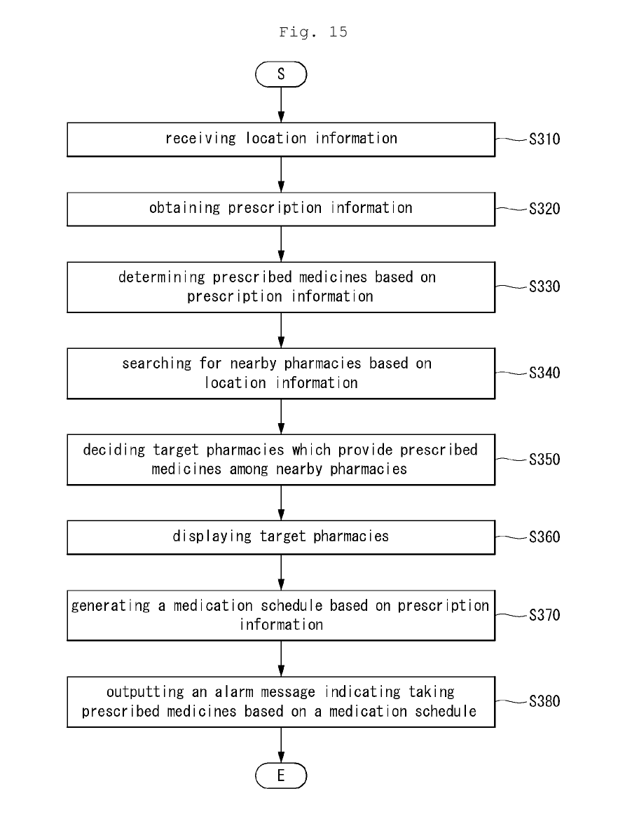

In the following, a method for providing a pharmacy guide according to a second embodiment of the present invention will be described with reference to FIGS. 12, 13, and 14. FIG. 12 is a flow chart of a method for providing a pharmacy guide according to a second embodiment of the present invention. FIG. 13 illustrates selecting a pharmacy in a method for providing a pharmacy guide according to a second embodiment of the present invention. FIG. 14 illustrates displaying additional information about a pharmacy in a method for providing a pharmacy guide according to a second embodiment of the present invention.

A method for providing a pharmacy guide according to a second embodiment of the present invention can comprise at least one of receiving location information S210, obtaining prescription information S220, determining prescribed medicines based on prescription information S230, searching for nearby pharmacies based on location information S240, deciding at least one target pharmacy which provide prescribed medicines among nearby pharmacies S250, displaying at least one target pharmacy S260, receiving a signal selecting a pharmacy among at least one target pharmacy S270, and displaying additional information about a pharmacy selected S280. In what follows, individual steps of the method for providing a pharmacy guide according to the second embodiment of the present invention will be described. Receiving location information S210, obtaining prescribed information S220, determining prescribed medicines based on prescription information S230, searching for nearby pharmacies based on location information S240, deciding at least one target pharmacy which provide prescribed medicines among nearby pharmacies S250, and displaying at least one target pharmacy S260 can be the same as described in a method for providing a pharmacy guide according to the first embodiment of the present invention.

The apparatus 100 for providing a pharmacy guide can receive a signal selecting a pharmacy among at least one target pharmacy by using the input module 150. The input module 150 can receive the signal in various ways. For example, the input module 150 and the output module 140 can be realized by a touch screen. As shown in FIG. 13, the touch screen can display at least one target pharmacy A, B, C and receive a touch signal selecting a pharmacy B from the user. A method by which the input module 150 receives a signal is not limited to the example above but can comprise all the methods which receive an input from the user.

The apparatus 100 for providing a pharmacy guide can output additional information about a selected pharmacy S280.

The output module 140 can output additional information about a selected pharmacy. At this time, the additional information about a pharmacy can include all the information useful for the user to use the pharmacy. To be specific, additional information about a pharmacy can include the name of the pharmacy, the address of the pharmacy, the phone number of the pharmacy, the Internet home page of the pharmacy, the pharmacist's name of the pharmacy, the business hours of the pharmacy, the inventory of medicines in stock of the pharmacy, the price of medicines provided by the pharmacy, the path from location according to location information to the pharmacy, and the travel time required to move to the pharmacy. The output module 140 can provide the user with the additional information by outputting the additional information as shown in FIG. 14.

The controller 170 can obtain the additional information and control the output module 140 to output the additional information about a selected pharmacy. At this time, the controller 170 can obtain additional information from the storage module 160 which stores the additional information about a pharmacy or by receiving the additional information from an external device through the communication module 130. At this time, the external device can include a pharmacy-side device 30 and a pharmacy guide server 10. To be specific, the pharmacy-side device 30 can receive the additional information from a pharmacy worker such as pharmacist, store the additional information, and provide the additional information. The pharmacy guide serer 10 can collect additional information about various pharmacies by obtaining additional information about a pharmacy from each pharmacy and provide the additional information.

According to a method for providing a pharmacy guide according to the second embodiment of the present invention, by providing overall additional information about a pharmacy, the user can more effectively purchase medicines.

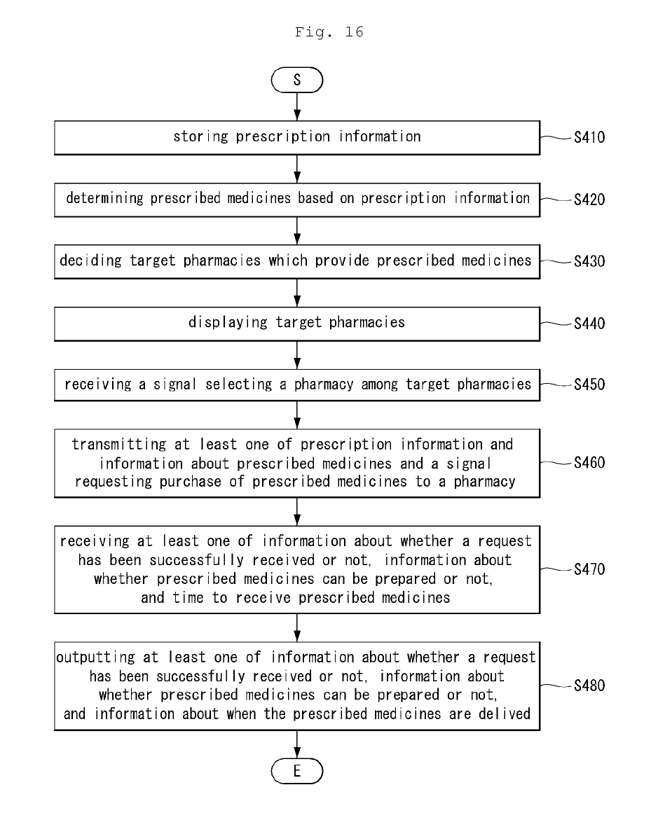

In the following, a method for providing a pharmacy guide according to a third embodiment of the present invention will be described with reference to FIG. 15. FIG. 15 is a flow chart of a method for providing a pharmacy guide according to a third embodiment of the present invention.

A method for providing a pharmacy guide according to a third embodiment of the present invention can comprise at least one of receiving location information S310, obtaining prescription information S320, determining prescribed medicines based on prescription information S330, searching for nearby pharmacies based on location information S340, deciding at least one target pharmacy which provide prescribed medicines among nearby pharmacies S350, displaying at least one target pharmacy S360, generating a medication schedule based on prescription information S370, and outputting an alarm message indicating taking prescribed medicines based on a medication scheduleS380. In what follows, individual steps of the method for providing a pharmacy guide according to the third embodiment of the present invention will be described. Receiving location information S310, obtaining prescribed information S320, determining prescribed medicines based on prescription information S330, searching for nearby pharmacies based on location information S340, deciding at least one target pharmacy which provide prescribed medicines among nearby pharmacies S350, and displaying at least one target pharmacy S360 can be the same as described in a method for providing a pharmacy guide according to the first embodiment of the present invention.

The apparatus 100 for providing a pharmacy guide can generate a medication schedule based on prescription information S370. The controller 170 can generate a medication schedule based on prescription information. The prescription information can include prescribed medicines, directions for taking the prescribed medicines, and cautions for taking the prescribed medicines. The controller 170, by taking account of the information overall, can determine a medication schedule according to the time at which the user has to take medicines. For example, if medicine A has been prescribed according to prescription information, the amount of prescribed medicine is for three days. The date of prescription is Jan. 1, 2001; and directions for taking the prescribed medicine indicate taking the medicine three times a day and two pills for each time. The controller 170, based on the prescription information, can determine the time to take medicines by 10 AM, 2 PM, and 6 PM each day from Jan. 1, 2001 to Jan. 4, 2001 and generate a medication schedule according thereto.

At this time, the controller 170 can generate a medication schedule by further taking account of body information of the user. The body information can include name, sex, age, height, weight, a medical history, blood sugar, blood pressure, and health status of the user. The body information can be stored in the storage module 160 or the communication module 130 can obtain the body information from external devices such as a pharmacy guide server 10, a hospital-side device 20, and an Internet site. For example, the controller 170 can generate a medication schedule by further taking account of the age of the user. To be specific, if the age of the user is five, the amount of medication can be reduced by half. In case of an adult, the number of times to take medicines can be reduced to two when directions indicate three times a day.

The apparatus 100 for providing a pharmacy guide can output an alarm message indicating taking prescribed medicines based on a medication schedule by using the output module 140 to output an alarm message at the time to take medicines according to the medication schedule. The controller 170 can determine whether the time to take medicines according to a medication schedule has come and control the output module 140 to output an alarm message at the time to take medicines. At this time, the alarm message can include at least one of a visual signal, an auditory signal, and a tactile signal. The output module 140 can include at least one of a screen, a speaker, and a vibrator, and output the signal.

According to a method for providing a pharmacy guide according to the third embodiment of the present invention, by generating a medication schedule by making use of prescription information and outputting an alarm message at the time to take medicines according to the generated schedule, the user can take prescribed medicines at each time indicated by the prescription information.

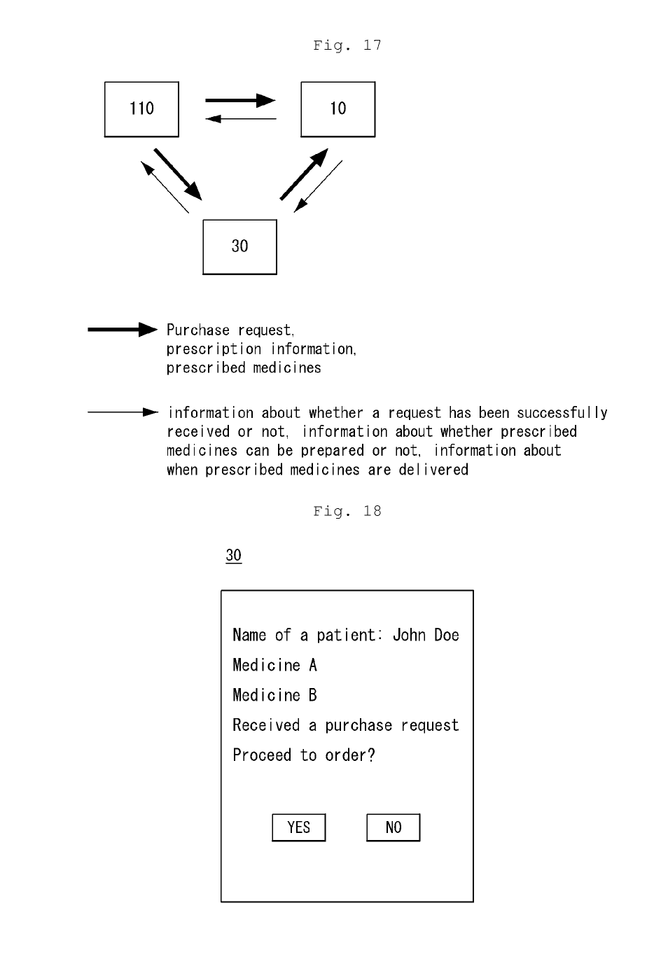

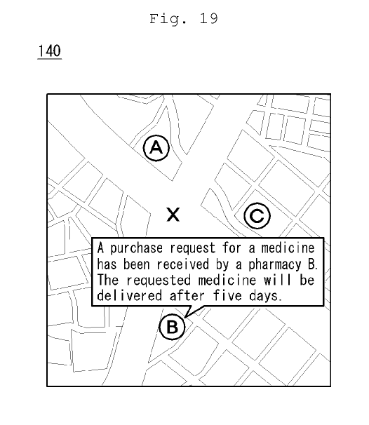

In the following, a method for providing a pharmacy guide according to a fourth embodiment of the present invention will be described with reference to FIGS. 16, 17, 18, and 19. FIG. 16 is a flow chart of a method for providing a pharmacy guide according to a fourth embodiment of the present invention. FIG. 17 illustrates communication with an external device in a method for providing a pharmacy guide according to a fourth embodiment of the present invention. FIG. 18 illustrates a confirmation interface for purchasing medicines in a method for providing a pharmacy guide according to a fourth embodiment of the present invention. FIG. 19 illustrates an interface for confirming a reception in a method for providing a pharmacy guide according to a fourth embodiment of the present invention.

As shown in FIG. 16, a method for providing a pharmacy guide according to a fourth embodiment of the present invention can comprise obtaining prescription information, at least one of storing prescription information S410, determining prescribed medicines based on prescription information S420, choosing at least one target pharmacy which provide the prescribed medicines S430, displaying at least one target pharmacy S440, receiving a signal selecting a pharmacy among at least one target pharmacy S450, transmitting at least one of prescription information and information about prescribed medicines to a pharmacy and a signal requesting a purchase of prescribed medicines S460, receiving at least one of information indicating whether or not the request are confirmed, information indicating whether or not the prescribed medicines can be prepared, and information time when the prescribed medicines are delivered S470, and outputting at least one of three information which mentioned above S480. In what follows, individual steps of the method for providing a pharmacy guide according to the fourth embodiment of the present invention will be described. Determining prescribed medicines based on prescription information S420, deciding at least one target pharmacy which provide prescribed medicines S430, and displaying at least one target pharmacy S440 can be the same as described in a method for providing a pharmacy guide according to the first embodiment of the present invention. Receiving a signal selecting a pharmacy among at least one target pharmacy S450 can be the same as described in a method for providing a pharmacy guide according to the second embodiment of the present invention.

The apparatus 100 for providing a pharmacy guide can store prescription information in the storage module 160. The controller 170 can obtain prescription information using the same method as described in a method for providing a pharmacy guide according to the first embodiment of the present invention and store the prescription information in the storage module 160.

The apparatus 100 for providing a pharmacy guide can transmit at least one of prescription information and information about prescribed medicines to a pharmacy and a signal requesting purchase of prescribed medicines S460.

The communication module 130 can transmit at least one of prescription information and information about prescribed medicines to a selected pharmacy and a signal requesting purchase of prescribed medicines S460. The controller 170 can choose a pharmacy based on a signal received by the input module 150 and as shown in FIG. 17, transmit at least one of prescription information and information about prescribed medicines to the pharmacy and a signal requesting purchase of prescribed medicines. At this time, the communication module 130 can transmit the signal to a pharmacy-side device 30. Or the communication module 130 can transmit the signal to a pharmacy guide server 10 and the pharmacy guide server 10 can transmit the signal to the pharmacy-side device 30. Or the communication module 130 can transmit the signal to an Internet site and the pharmacy-side device 30 can receive the signal from the Internet site. The pharmacy-side device 30 can receive the signal and provide a pharmacist with information indicating reception of the signal requesting purchase of prescribed medicines. In addition, the pharmacy-side device 30 can provide a pharmacist with prescription information and information required for providing and preparing medicines such as information about prescribed medicines. A pharmacist can select or prepare medicines based on the information above.

The apparatus 100 for providing a pharmacy guide can receive at least one of information indicating whether or not the request are confirmed, information indicating whether or not the prescribed medicines are prepared, and information about time when the prescribed medicines are delivered. The communication module 130 can receive the information above from the pharmacy-side device 30.

For example, the pharmacy-side device 30 can receive a signal requesting a purchase of prescribed medicines from the apparatus 100 for providing a pharmacy guide and as shown in FIG. 18, provide an interface for confirmation of purchasing prescribed medicines. The pharmacy-side device 30 can receive a signal reflecting a response to the request for purchasing prescribed medicines through the interface from a pharmacist or a pharmacy. According thereto, the pharmacy-side device 30 can transmit a signal reflecting reception or confirmation of a request to the apparatus 100 for providing a pharmacy guide and the communication module 130 can obtain the signal.

In another example, the pharmacy-side device 30 can receive prescription information or information about prescribed medicines from the apparatus 100 for providing a pharmacy guide and as shown in FIG. 18, display information about prescribed medicines. A pharmacist can select or prepare medicines by using the information above and the pharmacy-side device 30 can receive a response from the user whether he or she can receive the medicines. The pharmacy-side device 30 can receive information about whether the user can receive the medicines or the date the user can receive the medicines and transmit the information to the apparatus 100 for providing a pharmacy guide. The apparatus 100 for providing a pharmacy guide can receive the information above.

The communication module 130 can perform communication with other external devices without directly communicating with the pharmacy-side device 30. For example, the pharmacy-side device 30 can transmit the information described above to the pharmacy guide server 10 or an Internet site and the apparatus 100 for providing a pharmacy guide can receive the information from the pharmacy guide server 10 or the Internet site.

The apparatus 100 for providing a pharmacy guide 100 can output at least one of information indicating whether or not the request is confirmed, information indicating whether or not the prescribed medicines are prepared, and information about time when the prescribed medicines are delivered S480.

The controller 170 can control the output module 140 to output at least one of the three information which mentioned above and received from the communication module 130. As shown in FIG. 19, the output module 140 can display the information above and the user can easily purchase prescribed medicines by receiving the information.

According to a method for providing a pharmacy guide according to the fourth embodiment of the present invention, by performing purchase of prescribed medicines through communication with a pharmacy, the user can purchase prescribed medicines without visiting the pharmacy directly. In addition, since information required for preparing and selecting medicines such as prescription information is transmitted to the pharmacy and a pharmacist is provided with prescription information by the pharmacy-side device 30, the user can be provided with prescribed medicines from the pharmacist without directly delivering a prescription to the pharmacist. Moreover, by requesting purchase of medicines through communication beforehand, the user can directly receive the medicines without spending a waiting time for preparation of the medicines at the pharmacy.

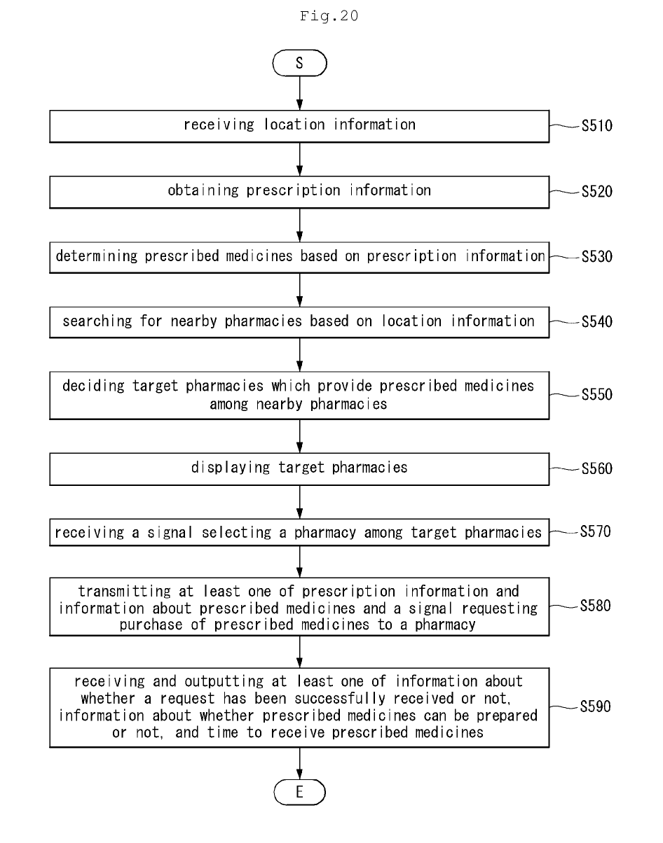

In the following, a method for providing a pharmacy guide according to a fifth embodiment of the present invention will be described with reference to FIG. 20. FIG. 20 is a flow chart of a method for providing a pharmacy guide according to a fifth embodiment of the present invention.

As shown in FIG. 20, a method for providing a pharmacy guide according to a fifth embodiment of the present invention can comprise at least one of receiving location information S510 obtaining prescription information S520 determining prescribed medicines based on prescription information S530 searching for nearby pharmacies based on location information S540, deciding at least one target pharmacy which provide prescribed medicines among nearby pharmacies S550, displaying at least one target pharmacy S560, receiving a signal selecting a pharmacy among at least one target pharmacy S570, transmitting at least one of prescription information and information about prescribed medicines and a signal requesting purchase of prescribed medicines to a pharmacy S580, and receiving and outputting at least one of information indicating whether or not the request are confirmed, information indicating whether or not the prescribed medicines are prepared, and information about time when the prescribed medicines are delivered S590.

In what follows, individual steps of the method for providing a pharmacy guide according to the fifth embodiment of the present invention will be described. Receiving location information S510, obtaining prescription information S520, determining prescribed medicines based on prescription information S530, searching for nearby pharmacies based on location information S540, deciding at least one target pharmacy which provide prescribed medicines among nearby pharmacies S550, and displaying at least one target pharmacy S560 can be the same as described in a method for providing a pharmacy guide according to the first embodiment of the present invention.

Receiving a signal selecting a pharmacy among at least one target pharmacy S570 transmitting at least one of prescription information and information about prescribed medicines and a signal requesting purchase of prescribed medicines to a pharmacy S580, and receiving and outputting at least one of information about whether a request has been successfully received or not, information about whether prescribed medicines can be prepared or not, and time to receive prescribed medicines S590 can be the same as described in a method for providing a pharmacy guide according to the fourth embodiment of the present invention.

Since the method for providing a pharmacy guide according to the fifth embodiment of the present invention is a combination of a method for providing a pharmacy guide according to the first embodiment of the present invention and a method for providing a pharmacy guide according to the second embodiment of the present invention, the method for providing a pharmacy guide according to the fifth embodiment of the present invention will be understood by referring to the descriptions of a method for providing a pharmacy guide according to the first embodiment and a method for providing a pharmacy guide according to the second embodiment of the present invention.

According to the method for providing a pharmacy guide according to the fifth embodiment of the present invention, an overall pharmacy guide service ranging from the time of receiving treatment and a prescription from a doctor to the time of purchasing prescribed medicines at a pharmacy can be carried out.

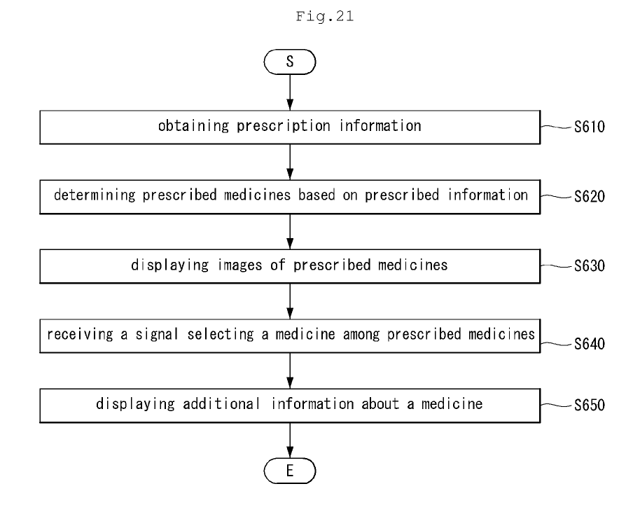

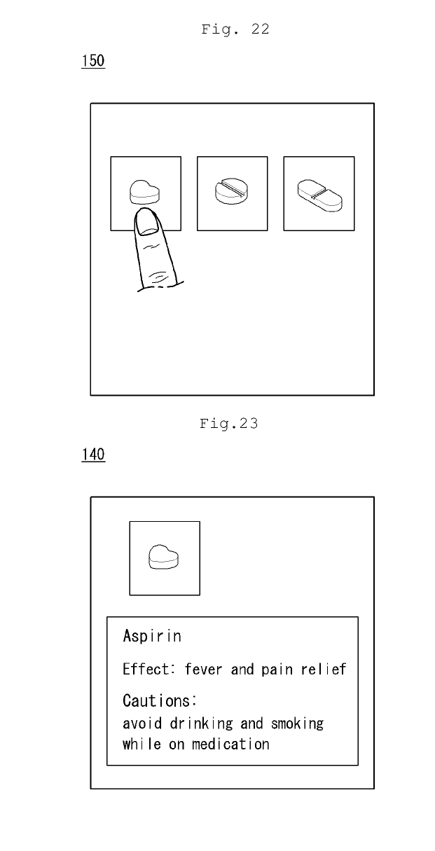

In the following, a method for providing a pharmacy guide according to a sixth embodiment of the present invention will be described with reference to FIGS. 21, 22, and 23. FIG. 21 is a flow chart of a method for providing a pharmacy guide according to a sixth embodiment of the present invention. FIG. 22 illustrates selecting a medicine in a method for providing a pharmacy guide according to a sixth embodiment of the present FIG. 23 illustrates displaying additional information about a medicine in a method for providing a pharmacy guide according to a sixth embodiment of the present invention.

As shown in FIG. 21, a method for providing a pharmacy guide according to a sixth embodiment of the present invention can comprise at least one of obtaining prescription information S610, determining prescribed medicines based on prescription information S620, displaying images of prescribed medicines S630, selecting a medicine among prescribed medicines and receiving a signal S640, and displaying additional information about a medicine S650. In what follows, individual steps of the method for providing a pharmacy guide according to the sixth embodiment of the present invention will be described. Obtaining prescription information S610 and determining prescribed medicines based on prescription information S620 can be the same as described in a method for providing a pharmacy guide according to the first embodiment of the present invention.

The apparatus 100 for providing a pharmacy guide can display images of prescribed medicines by using the output module 140. The storage module 160 can store information about a medicine and the information about a medicine can include at least one of an image of the medicine and additional information about the medicine. The communication module 130 can receive information about a medicine from an external device 30 such as a pharmacy guide server 10 and the controller 170 can store the received information in the storage module 160. The controller 170 can obtain prescription information, decide prescribed medicines by analyzing prescription information, select information about prescribed medicines among information about medicines stored in the storage module 160, and control the output module 140 to display images of prescribed medicines. For example, when medicines A, B, C have been prescribed according to prescription information, as shown in FIG. 22, the controller 170 can control the output module 140 to output the images of the prescribed medicines A, B, C.

The apparatus 100 for providing a pharmacy guide can select a medicine among prescribed medicines and receive a signal S640. The input module 150 can receive a signal selecting a medicine among prescribed medicines. If prescribed medicines consist of the same kind of a medicine, a signal selecting a medicine can be ignored. The controller 170 can receive a signal selecting a medicine through the input module 150 and select a medicine according to the signal. For example, as shown in FIG. 22, a touch screen can display images of medicines A, B, C and receive a touch signal selecting one from among the three images.

The apparatus 100 for providing a pharmacy guide can display additional information about a medicine by using the output module 140. At this time, additional information about a medicine can include at least name of a medicine, effect of the medicine, cautions when taking the medicine, information about a medicine prohibited to take together with the selected medicine, a disease corresponding to the medicine, valid date of the medicine, price of the medicine, and various kinds of other information. The communication module 130 can receive additional information about a medicine from an external device such as a pharmacy guide server 10 and the controller 170 can store the received information in the storage module 160. As shown in FIG. 23, the controller 170 can control the output module 140 to display additional information about a medicine selected according to a signal received by the input module 150.

According to the method for providing a pharmacy guide according to the sixth embodiment of the present invention, by displaying images of prescribed medicines by using prescription information, the user can be guided to correctly take medicines. In addition, by providing detailed information about prescribed medicines, the user can correctly take medicines.

Methods for providing a pharmacy guide according to the respective embodiments of the present invention described above can be used individually or in combination with each other. For example, an apparatus receiving prescription information and displaying nearby pharmacies that have the ability to provide the prescribed medications can output additional information regarding the pharmacy, as depicted in FIG. 12, set a schedule and alarms for the taking of the medication, as depicted in FIG. 15, order the medication from a chosen pharmacy and receive confirmation of the order, as depicted in FIGS. 16 and 20 and provide a picture and additional information regarding the prescribed medications, as depicted in FIG. 21. In this manner, a single apparatus can provide all the features of the invention. In addition, individual steps constituting each embodiment can be used individually or in combination with the steps constituting other embodiments.

According to the present invention described above, the user can use medicines and a pharmacy correctly since an overall guide about a medical service from prescription to reception of the medicines is provided. In addition, according to the present invention, each person can lead a healthy life according to the advantageous effects described above and from a societal point of view, a waste of unnecessary medical costs can be reduced.

Since the present invention described above can be substituted, modified, and changed in various ways by those skilled in the art to which the present invention belongs without departing the technical principles of the present invention, the present invention is not limited to the embodiments described above and appended drawings. In addition, embodiments described in this document are not intended to limited applications but the whole of the embodiments or part thereof can be selectively combined to allow various modifications of the embodiments.

What is claimed is:

1. An apparatus for providing a pharmacy guide, the apparatus comprising:
a location obtaining module configured to obtain location information;
a controller configured to:
obtain prescription information,
determine prescribed medicines based on the prescription information,
search for nearby pharmacies based on the location information, the nearby pharmacies being within a predetermined range of a location according to the location information,
and
choose at least one target pharmacy providing the prescribed medicines among the nearby pharmacies; and
an output module configured to display the at least one target pharmacy.

2. The apparatus of claim 1, further comprising a camera configured to capture an image of an object reflecting the prescription information, wherein the controller obtains the prescription information by analyzing the image of the captured object.

3. The apparatus of claim 2, wherein the object includes at least one of a prescription where the prescription information is written or printed and an identification code containing the prescription information.

4. The apparatus of claim 1, further comprising a communication module configured to receive the prescription information from an external device, wherein the controller obtains the prescription information via the communication module.

5. The apparatus of claim 1, further comprising a storage module configured to store geographic information, wherein the controller searches for the nearby pharmacies within the predetermined range based on the location according to the location information by using the geographic information.

6. The apparatus of claim 1, wherein the controller chooses the at least one target pharmacy which provides the prescribed medicines from among the nearby pharmacies based on the medicine inventory information.

7. The apparatus of claim 1, further comprising an input module configured to receive a signal selecting a pharmacy from among the at least one target pharmacy.

8. The apparatus of claim 7, further comprising a communication module configured to transmit a signal requesting a purchase of the prescribed medicines to the selected pharmacy.

9. The apparatus of claim 8, wherein the communication module receives at least one of information about whether or not the request has been successfully received, information about whether or not the prescribed medicines are prepared, and information about when the prescribed medicines are delivered; and
wherein the output module outputs at least one of the information indicating whether or not the request are confirmed, the information indicating whether or the prescribed medicines are prepared, and the information about time when the prescribed medicines are delivered.

10. The apparatus of claim 8, wherein the communication module transmits at least one of the prescription information and information about the prescribed medicines to the selected pharmacy.

11. The apparatus of claim 7, wherein the output module outputs additional information about the selected pharmacy.

12. The apparatus of claim 11, wherein the additional information about the selected pharmacy includes at least one of a name of the selected pharmacy, an address of the selected pharmacy, a phone number of the selected pharmacy, an Internet home page of the selected pharmacy, a pharmacist's name of the selected pharmacy, a business hours of the selected pharmacy, an inventory of medicines in stock of the selected pharmacy, a price of medicines provided by the selected pharmacy, a path from the location according to the location information to the selected pharmacy, and a travel time required to move to the selected pharmacy.

13. The apparatus of claim 1, wherein the controller generates a medication schedule based on the prescription information and controls the output module to output an alarm message indicating taking the prescribed medicines based on the medication schedule.

14. The apparatus of claim 13, wherein the controller generates an alarm according to the schedule.

15. The apparatus of claim 8, wherein the communication module receives at least one of information about whether the request has been successfully received or not, information about whether the prescribed medicines can be prepared or not, and time to receive the prescribed medicines; and the output module outputs at least one of information indicating whether or not the request are confirmed, information indicating whether or not the prescribed medicines are prepared, and information about time when the prescribed medicines are delivered.

16. A method for providing a pharmacy guide, comprising:
obtaining location information; obtaining prescription information;
determining prescribed medicines based on the prescription information;
choosing at least one pharmacy which provides the prescribed medicines and is located within a predetermined range based on the location information; and
displaying the at least one target pharmacy on a display.

17. The method for providing a pharmacy guide of claim 16, further comprising:
receiving a signal selecting a pharmacy among the at least one target pharmacy; and
transmitting at least one of the prescription information and information about the prescribed medicines; and a request signal for purchasing the prescribed medicines to the selected pharmacy.

18. The method for providing a pharmacy guide of claim 16, further comprising:
receiving additional information regarding the chosen pharmacy.

19. The method for providing a pharmacy guide of claim 16, further comprising:
receiving information regarding the prescribed medicines; and
outputting information regarding the prescribed medicines.

20. The method for providing a pharmacy guide of claim 19, wherein the information regarding the prescribed medicines is obtained from a storage unit.
